(19) United States
(12) Patent Application Publication
(10) Pub. No.: US 2025/0100891 A1
(43) Pub. Date: Mar. 27, 2025

(54) METHOD FOR PRODUCING HOLLOW SILICA PARTICLES

(71) Applicant: KAO CORPORATION, Tokyo (JP)

(72) Inventors: Hiroki HOSHIDA, Wakayama-shi (JP); Fumiya HAMADA, Wakayama-shi (JP)

(73) Assignee: KAO CORPORATION, Tokyo (JP)

(21) Appl. No.: 18/730,586

(22) PCT Filed: Jan. 23, 2023
(86) PCT No.: PCT/JP2023/001898

§ 371 Date: Jul. 19, 2024

(30) Foreign Application Priority Data
Jan. 21, 2022 (JP) 2022-008120

(51) Int. Cl. C01B 33/18; C08K 7/26

(52) U.S. Cl. CPC C01B 33/18; C08K 7/26; C01P 2004/61; C01P 2004/62; C01P 2006/12; C01P 2006/40; C01P 2006/80

(57) ABSTRACT

A method for producing hollow silica particles having an average particle diameter of 0.5 μm or more and 3.0 μm or less and a total content of alkali metals and alkaline earth metals of 50 mass ppm or less with respect to a content of the silica in the particles, wherein the hollow silica particles have a relative permittivity of 2.5 or less and a dielectric dissipation factor of 0.0050 or less at a measurement frequency of 5.8 GHZ, and the method includes the following steps. Step A: a step of making an aqueous emulsion of a hydrophobic liquid using a cationic surfactant A; Step B: a step of adding, to the aqueous emulsion obtained in Step A, a silanol precursor, an alkaline substance, and a cationic surfactant B, and generating a hollow silica particle precursor; Step C: a step of heat-treating the hollow silica particle precursor obtained in Step B at a temperature higher than 1000° C. and 1200° C. or lower for one hour or more.

### FIELD OF THE INVENTION

The present invention relates to a method for producing hollow silica particles, hollow silica particles, a resin composition blended with the hollow silica particles, and an insulating material.

### BACKGROUND OF THE INVENTION

The use of high frequency of tens of GHz is being considered for high-speed communication technology represented by 5G and radar used for autonomous driving. In high frequency circuits that support high frequency radio waves, insulating materials with a low dielectric constant and a low dielectric dissipation factor are required to reduce transmission loss and transmission delay, and currently, a low dielectric constant and a low dielectric dissipation factor are also required for silica particles that are blended into insulating materials to improve thermal properties. Moreover, miniaturization of high frequency circuits is desired, and a reduction in the particle size of silica particles to be blended into insulating materials is also required.

Currently, the use of hollow silica particles is being considered to lower the dielectricity of silica particles.

For example, PTL 1 discloses spherical hollow silica having an average particle diameter of 8 μm or less, an average sphericity of 0.85 or more, and an average porosity in the range of 20 to 70% by volume.

In addition, PTL 2 discloses silica-based particles having a cavity inside a non-porous outer shell silica layer, a porosity in the range of 20 to 95% by volume, and an average particle diameter in the range of 0.1 to 50 μm.

Further, PTL 3 discloses hollow silica having a shell layer containing silica and having a space inside the shell layer, and hollow silica particles having a relative permittivity of 1.3 to 5.0 at 1 GHz, and a dielectric dissipation factor of 0.0001 to 0.05 at 1 GHz.

Moreover, PTL 4 discloses a method for producing hollow silica particles having the following steps 1 to 3. Step 1: a step of adding liquid B containing a hydrophobic organic substance, a hydrophilic organic solvent, and a surfactant to liquid A containing 70% by mass or more of water, and obtaining an emulsion in which the amount of the hydrophobic organic substance is 1.0 parts by mass or more and 20 parts by mass or less based on 100 parts by mass of water. Step 2: a step of adding a silica source to the obtained emulsion and forming an outer shell containing silica in the presence of an alkaline substance to obtain composite silica particles. Step 3: a step of removing the hydrophobic organic substance from the composite silica particles to obtain hollow silica particles.

### CITATION LIST

### Patent Literature

PTL 1: JP 2005-206436 A
PTL 2: JP 2013-103850 A
PTL 3: WO 2021/172294 A
PTL 4: JP 2016-121060 A

### SUMMARY OF THE INVENTION

However, the spherical hollow silica disclosed in PTL 1 is produced as spherical hollow silica having various particle diameters by supplying fine silica particles into a high temperature flame. Therefore, spherical hollow silica with a low relative permittivity has a large particle size and is difficult to use in miniaturized circuit boards, and spherical hollow silica with a small particle size has a low porosity. As a result, there is a problem that the relative permittivity is not much different from that of solid silica.

In addition, the silica-based particles disclosed in PTL 2 are produced by spray-drying an aqueous alkali silicate solution and then subjecting it to hydrothermal treatment. Therefore, although the obtained silica-based particles have a low relative permittivity, there is a problem of a high dielectric dissipation factor because the particles have a large number of silanol groups generated by hydrothermal treatment.

Moreover, PTL 3 discloses that by firing hollow silica particles containing a metal selected from alkali metals or alkaline earth metals, metal ions thereof function as a flux during firing, reducing the specific surface area and promoting condensation of the silanol groups. As the silanol groups contained in the hollow silica particles are reduced, the dielectric dissipation factor is reduced. However, as described in JP 2016-94527 A for example, alkali metals are known to reduce the insulation properties of resin compositions, and there has been a problem that the hollow silica particles described in PTL 3 cannot be used as insulating materials, and when the content of alkali metals or alkaline earth metals is reduced, the dielectricity of the insulating materials cannot be made sufficiently low.

Furthermore, in PTL 4, during the reaction of silica precursors such as alkoxysilanes, it has been difficult to obtain particles with a low dielectric dissipation factor because a cationic surfactant is not separately added to the aqueous emulsion to control the reaction.

That is, to the best of the present inventors' knowledge, hollow silica with a small particle size and a low alkali metal and alkaline earth metal content, with sufficiently low relative permittivity and dielectric dissipation factor, has so far been unavailable for use in insulating materials.

Therefore, an object of the present invention is to provide a method for producing hollow silica particles having a small average particle diameter and a low relative permittivity and dielectric dissipation factor even when the content of alkali metals and alkaline earth metals is low, and to provide new hollow silica particles obtained thereby, as well as a resin composition blended with the hollow silica particles, and an insulating material.

The present invention relates to the following (1) to (4).
(1) A method for producing hollow silica particles having an average particle diameter of 0.5 μm or more and 3.0 μm or less and a total content of alkali metals and alkaline earth metals of 50 mass ppm or less with respect to a content of the silica in the particles, in which
the hollow silica particles have a relative permittivity of 2.5 or less and a dielectric dissipation factor of 0.0050 or less at a measurement frequency of 5.8 GHz, and
the method includes the following steps:
Step A: a step of making an aqueous emulsion of a hydrophobic liquid using a cationic surfactant A;
Step B: a step of adding, to the aqueous emulsion obtained in Step A, a silanol precursor, an alkaline substance, and a cationic surfactant B, and generating a hollow silica particle precursor; and
Step C: a step of heat-treating the hollow silica particle precursor obtained in Step B at a temperature higher than 1000° C. and 1200° C. or lower for one hour or more.
(2) Hollow silica particles having an average particle diameter of 0.5 μm or more and 3.0 μm or less and a total content of alkali metals and alkaline earth metals of 50 mass ppm or less with respect to a content of the silica in the particles, in which
the hollow silica particles have a relative permittivity of 2.5 or less and a dielectric dissipation factor of 0.0050 or less at a measurement frequency of 5.8 GHz.
(3) A resin composition blended with the hollow silica particles according to the above (2).
(4) An insulating material containing the resin composition according to the above (3).

According to the present invention, it is possible to provide a method for producing hollow silica particles having a small average particle diameter, a low content of alkali metals and alkaline earth metals, and a low relative permittivity and dielectric dissipation factor, and it is possible to provide unprecedented hollow silica particles, a resin composition blended with the hollow silica particles, and an insulating material.

### DETAILED DESCRIPTION OF THE INVENTION

### [Hollow Silica Particles]

The hollow silica particles of the present invention have an average particle diameter of 0.5 μm or more and 3.0 μm or less and a total content of alkali metals and alkaline earth metals of 50 mass ppm or less with respect to a content of the silica in the particles, and the hollow silica particles have a relative permittivity of 2.5 or less and a dielectric dissipation factor of 0.0050 or less at a measurement frequency of 5.8 GHz.

The average particle diameter of the hollow silica particles is, in terms of volume average particle diameter, 0.5 μm or more, preferably 0.7 μm or more, and more preferably 0.9 μm or more, from the viewpoint of lowering the viscosity when blended into the resin composition and maintaining processability, and is 3.0 μm or less, preferably 2.5 μm or less, and more preferably 2.0 μm or less, from the viewpoint of improving the appearance of the resin composition.

In addition, from the viewpoint of blending many hollow silica particles into the resin composition and reducing the relative permittivity and dielectric dissipation factor of the resin composition, the coefficient of variation of the average particle diameter of the hollow silica particles is preferably 15% or more, more preferably 20% or more, and even more preferably 25% or more, and is preferably 300% or less, more preferably 200% or less, even more preferably 100% or less, still more preferably 75% or less, and further more preferably 50% or less.

From the viewpoint of improving the appearance of the resin composition, the maximum particle diameter of the hollow silica particles is, in terms of volume average particle diameter, preferably 1.5 μm or more, more preferably 1.8 μm or more, and even more preferably 2.0 μm or more, and is preferably 5.0 μm or less, more preferably 4.7 μm or less, and even more preferably 4.5 μm or less.

The volume average particle diameter of the hollow silica particles can be determined by a method described in Examples.

The total content of alkali metals and alkaline earth metals relative to the content of silica in the hollow silica particles is, from the viewpoint of being suitably used in insulating materials, 50 mass ppm or less, preferably 30 mass ppm or less, more preferably 20 mass ppm or less, and even more preferably 15 mass ppm or less, and is, from the viewpoint of productivity of hollow silica particles, preferably 1 mass ppb or more, and more preferably 5 mass ppb or more.

The content of alkali metals and alkaline earth metals in the hollow silica particles can be measured by a method described in US EPA METHOD 3051A. Lithium, rubidium, and cesium in the hollow silica particles can also be measured by a method described in US EPA METHOD 3051A.

The relative permittivity of the resin composition blended with the hollow silica particles can be made sufficiently low when the relative permittivity of the hollow silica particles is 2.5 or less at a measurement frequency of 5.8 GHz. The relative permittivity at a measurement frequency of 5.8 GHz is, from the viewpoint of the strength of the hollow silica, preferably 1.1 or more, more preferably 1.2 or more, and even more preferably 1.3 or more, and is, from the viewpoint of sufficiently lowering the relative permittivity of the resin composition, preferably 2.2 or less, more preferably 2.0 or less, and even more preferably 1.8 or less.

The relative permittivity of the hollow silica particles can be determined by a method described in Examples.

The dielectric dissipation factor of the resin composition blended with the hollow silica particles can be made sufficiently low when the dielectric dissipation factor of the hollow silica particles is 0.0050 or less at a measurement frequency of 5.8 GHz. The dielectric dissipation factor at a measurement frequency of 5.8 GHz is, from the viewpoint of the strength of the hollow silica, preferably 0.0001 or more, more preferably 0.0005 or more, and even more preferably 0.001 or more, and is, from the viewpoint of sufficiently lowering the dielectric dissipation factor of the resin composition, preferably 0.0048 or less, more preferably 0.0046 or less, and even more preferably 0.0044 or less.

The dielectric dissipation factor of the hollow silica particles can be determined by a method described in Examples.

The porosity of the hollow silica particles is, from the viewpoint of lowering the relative permittivity of the hollow silica particles, preferably 50% by volume or more, more preferably 55% by volume or more, and even more preferably 60% by volume or more, and is, from the viewpoint that the hollow silica particles have sufficient strength, preferably 80% by volume or less, more preferably 77% by volume or less, and even more preferably 74% by volume or less.

The porosity of the hollow silica particles can be determined by a method described in Examples.

The BET specific surface area of the hollow silica particles is, from the viewpoint of increasing the porosity of the hollow silica and lowering the relative permittivity, preferably 5 m²/g or more, 7 m²/g or more, and 8.5 m²/g or more, and is, from the viewpoint of lowering the dielectric dissipation factor of the hollow silica particles, and from the viewpoint of reducing the amount of surface treatment agent used and lowering the dielectric dissipation factor of the resin composition when the hollow silica particles are blended into the resin, preferably 30 m²/g or less, more preferably 25 m²/g or less, and even more preferably 20 m²/g or less.

The BET specific surface area of the hollow silica particles can be determined by a method described in Examples.

### [Method for Producing Hollow Silica Particles]

The method for producing the hollow silica particles of the present invention is a method for producing hollow silica particles having an average particle diameter of 0.5 μm or more and 3.0 μm or less, and a total content of alkali metals and alkaline earth metals of 50 mass ppm or less with respect to a content of the silica in the particles in which the hollow silica particles have a relative permittivity of 2.5 or less and a dielectric dissipation factor of 0.0050 or less at a measurement frequency of 5.8 GHz, and the method includes the following steps:
Step A: a step of making an aqueous emulsion of a hydrophobic liquid using a cationic surfactant A;
Step B: a step of adding, to the aqueous emulsion obtained in Step A, a silanol precursor, an alkaline substance, and a cationic surfactant B, and generating a hollow silica particle precursor;
Step C: a step of heat-treating the hollow silica particle precursor obtained in Step B at a temperature higher than 1000° C. and 1200° C. or lower for one hour or more.

Although the reason why the hollow silica particles of the present invention have a small average particle diameter and a low relative permittivity and dielectric dissipation factor even when the content of alkali metals and alkaline earth metals is low is not clear, it is thought to be as follows.

In producing the hollow silica particles of the present invention, first, a silanol precursor is added to an aqueous emulsion of a hydrophobic liquid, and an alkaline substance and a cationic surfactant B are added thereto to coat the surface of droplets of the hydrophobic liquid with the silanol precursor. Thereafter, the silanol precursor is hydrolyzed to obtain a silanol, and the silanol is condensed to obtain a hollow silica particle precursor. When making the aqueous emulsion of the hydrophobic liquid, the particle size of the droplets of the hydrophobic liquid can be made sufficiently small, and thus the particle size of the hollow silica particle precursor can be set to a desired particle size. Supposedly since an aqueous emulsion of a hydrophobic liquid is made by using a cationic surfactant A and further adding a silanol precursor, an alkaline substance, and a cationic surfactant B, the silanol condensed with cationic surfactant micelles forms a complex and is incorporated into the outer shell of the hollow silica particle precursor.

The hydrophobic liquid incorporated into the hollow silica precursor evaporates through a gap between the silica and the cationic surfactant incorporated into the outer shell during drying or at an initial stage of firing, and thus large sized pores are not generated in the outer shell of the hollow silica precursor due to volatilization of the hydrophobic liquid during drying or firing.

Thereafter, the hollow silica particle precursor is heat-treated at a temperature higher than 1000° C. and 1200° C. or lower. At this time, the cationic surfactant incorporated into the outer shell of the hollow silica particle precursor in the initial stage decomposes and evaporates, thereby forming uniform pores with a size of several nanometers in the outer shell. Since the pore size is very small, a few nanometers, it is thought that even if it does not contain alkali metals or alkaline earth metals that serve as flux, the pores easily disappear in a high temperature state in a latter stage of firing, which makes the outer shell of the hollow silica particles uniform and dense and the dielectric dissipation factor low. Supposedly since the outer shell of the hollow silica particle precursor is dense without large pores, shrinkage during heat treatment can be reduced, and as a result of the increased porosity of the hollow silica particles, the relative permittivity is reduced.

### [Step A]

In step A, the cationic surfactant A and the hydrophobic liquid are mixed and stirred in a liquid A containing water to prepare an aqueous emulsion of the hydrophobic liquid in which droplets of the hydrophobic liquid are dispersed. The aqueous emulsion of the hydrophobic liquid can be prepared by a general method.

Examples of the water contained in the liquid A include distilled water, ion-exchanged water, and ultrapure water. The liquid A may contain an organic solvent that is compatible with water from the viewpoint of producing a more uniform and stable emulsion of the hydrophobic liquid. Examples of the organic solvent that is compatible with water include lower alcohols such as methanol, ethanol, and isopropyl alcohol, and acetone.

From the viewpoint of instantly reducing the solubility of the hydrophobic liquid in the liquid A, the content of water in the liquid A is preferably 80% by mass or more, more preferably 90% by mass or more, still more preferably 98% by mass or more, and even more preferably 100% by mass.

### (Cationic Surfactant A)

The cationic surfactant A is, from the viewpoint of facilitating the formation of a complex with the condensed silanol in Step B to be described later, and from the viewpoint of decomposition and volatilization in Step C to be described later, preferably a quaternary ammonium salt, more preferably at least one selected from an alkyltrimethylammonium salt and a dialkyldimethylammonium salt, and still more preferably at least one selected from the group consisting of quaternary ammonium salts shown in the following general formula (1) or general formula (2).

[R¹R³₃N]⁺X⁻ (1)

[R¹R²R³₂N]⁺X⁻ (2)

In the general formula (1) and the general formula (2), R¹ and R² each independently represent a linear or branched alkyl group having 4 to 22 carbon atoms, R³ represents an alkyl group having 1 to 3 carbon atoms, these plural R³s may be different groups from each other, and X⁻ represents a monovalent anion.

Examples of the alkyl group having 4 to 22 carbon atoms include various butyl groups, various pentyl groups, various hexyl groups, various heptyl groups, various octyl groups, various nonyl groups, various decyl groups, various dodecyl groups, various tetradecyl groups, various hexadecyl groups, various octadecyl groups, and various eicosyl groups.

Examples of the alkyl group having 1 to 3 carbon atoms include a methyl group, an ethyl group, an n-propyl group, and an isopropyl group. In the general formula (1) and the general formula (2), R³ is preferably a methyl group.

X⁻ in the general formulas (1) and (2) is preferably at least one type selected from monovalent anions such as halogen ions, hydroxide ions, and nitrate ions, from the viewpoint of easy decomposition and volatilization during firing. X⁻ is more preferably a halide ion, and even more preferably a chloride ion.

Examples of the alkyltrimethylammonium salt represented by the general formula (1) include butyltrimethylammonium chloride, hexyltrimethylammonium chloride, octyltrimethylammonium chloride, decyltrimethylammonium chloride, lauryltrimethylammonium chloride (dodecyltrimethylammonium chloride), tetradecyltrimethylammonium chloride, hexadecyltrimethylammonium chloride, stearyltrimethylammonium chloride, behenyltrimethylammonium chloride, butyltrimethylammonium bromide, hexyltrimethylammonium bromide, octyltrimethylammonium bromide, decyltrimethylammonium bromide, lauryltrimethylammonium bromide, tetradecyltrimethylammonium bromide, hexadecyltrimethylammonium bromide, stearyltrimethylammonium bromide, and behenyltrimethylammonium bromide.

Examples of the dialkyldimethylammonium salt represented by the general formula (2) include dibutyldimethylammonium chloride, dihexyldimethylammonium chloride, dioctyldimethylammonium chloride, dihexyldimethylammonium bromide, dioctyldimethylammonium bromide, dilauryldimethylammonium bromide, and ditetradecyldimethylammonium bromide.

From the viewpoint of facilitating the formation of a complex with the condensed silanol in Step B, and from the viewpoint of facilitating decomposition and volatilization in Step C, the quaternary ammonium salt is preferably lauryltrimethylammonium chloride, stearyltrimethylammonium chloride, and behenyltrimethylammonium chloride, and more preferably stearyltrimethylammonium chloride and behenyltrimethylammonium chloride.

### (Hydrophobic Liquid)

The hydrophobic liquid is preferably one that can form emulsified droplets (emulsified oil droplets) in water. In addition, from the viewpoint of using the liquid A containing water as a dispersion medium and from the viewpoint of improving the utilization efficiency of the hydrophobic liquid, it is preferable that the temperature range in the liquid state is 0 to 100° C., and more preferably 20 to 90° C.

Specific examples of the hydrophobic liquid include those described in paragraphs [0015] to of JP 2016-121060 A. Among these, hydrocarbons having 6 to 18 carbon atoms are preferred, hydrocarbons having 8 to 14 carbon atoms are more preferred, and dodecane is even more preferred.

In Step A, the mass ratio of the hydrophobic liquid to water [hydrophobic liquid/water] is, from the viewpoint of keeping the particle size of the resulting hydrophobic liquid droplets within an appropriate range, preferably 0.3 or more, more preferably 0.35 or more, and even more preferably 0.4 or more, and is preferably 0.8 or less, more preferably 0.75 or less, and even more preferably 0.7 or less.

In Step A, the mass ratio of the cationic surfactant A to the hydrophobic liquid [cationic surfactant A/hydrophobic liquid] is, from the viewpoint of dispersing the hydrophobic liquid in the liquid A, preferably 0.0005 or more, more preferably 0.001 or more, and still more preferably 0.0015 or more, and is preferably 0.05 or less, more preferably 0.04 or less, and still more preferably 0.035 or less.

In Step A, by appropriately adjusting stirring speed, temperature and the like, the particle size of the resulting droplets containing the hydrophobic liquid can be set within an appropriate range. Preferably, Step A is carried out at a temperature of 15° C. to 80° C.

From the viewpoint of keeping the average particle diameter of the hollow silica particles within the above range, the volume average particle diameter of the droplets containing the hydrophobic liquid is preferably 0.1 μm or more, more preferably 0.3 μm or more, and even more preferably 0.4 μm or more, and is preferably 2.5 μm or less, more preferably 2.0 μm or less, and even more preferably 1.5 μm or less.

The volume average particle diameter of the droplets containing the hydrophobic liquid can be determined by a method described in Examples.

### [Step B]

In Step B, a silanol precursor, an alkaline substance, and a cationic surfactant B are added to the aqueous emulsion obtained in Step A to produce a hollow silica particle precursor. Specifically, first, a silanol precursor present on the surface of the droplet of the hydrophobic liquid is hydrolyzed in the presence of an alkaline substance to obtain a silanol. Then, by condensing the obtained silanol in the presence of an alkaline substance, a hollow silica particle precursor having an outer shell containing silica and the cationic surfactant B on the surface of the droplet of the hydrophobic liquid and containing the hydrophobic liquid inside is formed.

The addition of the silanol precursor, the alkaline substance, and the cationic surfactant B to the aqueous emulsion may be carried out by adding the silanol precursor and the cationic surfactant B to the aqueous emulsion simultaneously or separately, or by adding the aqueous emulsion to either one of the silanol precursor and the cationic surfactant B and then adding the remaining one of the silanol precursor and the cationic surfactant B.

Step B may include, after the hollow silica particle precursor is formed and before Step C, a step of isolating the hollow silica particle precursor and a step of drying the hollow silica particle precursor. The hollow silica particles can be isolated, for example, by filtration. In addition, when the boiling point of the hydrophobic liquid contained in the hollow silica particle precursor is higher than 100° C., drying of the hollow silica particle precursor may be performed by heating to a temperature of 100° C. or higher and equal to or lower than the boiling point of the hydrophobic liquid, for example. When the boiling point of the hydrophobic liquid contained in the hollow silica particle precursor is 100° C. or lower, the hollow silica particle precursor can be dried, for example, by freeze-drying.

### (Silanol Precursor)

The silanol precursor is a compound that generates a silanol compound by hydrolysis of alkoxysilane, etc., and is preferably selected from orthosilicate alkyl ester and pyrosilicate alkyl ester. Specific examples thereof include compounds represented by the following general formulas (3) to (7), or a combination thereof.

SiY₄ (3)

R³SiY₃ (4)

R³₂SiY₂ (5)

R³₃SiY (6)

Y₃Si—O—SiY₃ (7)

In the general formulas (3) to (7), R³s each independently represents an organic group in which a carbon atom is directly bonded to a silicon atom, and Y represents a monovalent hydrolyzable group that becomes a hydroxy group upon hydrolysis.

In the general formulas (4) to (6), R³s each independently are preferably a hydrocarbon group having 1 to 22 carbon atoms in which some of the hydrogen atoms may be substituted with fluorine atoms, and are, from the viewpoint of improving the utilization efficiency of hydrophobic organic substances, an alkyl group preferably having 1 to 22 carbon atoms, more preferably 4 to 18 carbon atoms, and even more preferably 8 to 16 carbon atoms, a phenyl group, or a benzyl group.

In the general formulas (3) to (7), Y is preferably an alkoxy group having 1 to 8 carbon atoms or a halogen group excluding fluorine, and more preferably an alkoxy group having 2 to 4 carbon atoms. When Y is an alkoxy group having one carbon atom and a halogen group excluding fluorine, the reaction rate of hydrolysis is too high, which makes it difficult for the outer shell of the hollow silica precursor to become dense and causes large shrinkage during firing. As a result, the relative permittivity and the dielectric dissipation factor of the hollow silica particles tend to become high. Conversely, in the case of an alkoxy group having 5 or more carbon atoms, the hydrolysis rate becomes low.

The silanol precursor is preferably selected from compounds represented by the general formula (3) and the general formula (7). From the viewpoint of suppressing the generation of a metal corrosive acid and from the viewpoint of hydrolysis reactivity, the silanol precursor is preferably selected from compounds represented by the general formula (3) and the general formula (7) in which Y is an alkoxy group having 2 to 4 carbon atoms, and more preferably selected from compounds represented by the general formula (3) and the general formula (7) in which Y is an ethoxy group. The silanol precursor can be used alone or in combination of two or more types thereof.

The mass ratio of the silanol precursor to the hydrophobic liquid [silanol precursor/hydrophobic liquid] is, from the viewpoint of keeping the porosity of the hollow silica particles within an appropriate range, preferably 10 or more, more preferably 20 or more, and even more preferably 25 or more, and is preferably 90 or less, more preferably 80 or less, and even more preferably 75 or less.

### (Cationic Surfactant B)

As the cationic surfactant B, a cationic surfactant B the same as the cationic surfactant A shown in Step A can be used. From the viewpoint of facilitating the formation of a complex with the condensed silanol, and from the viewpoint of facilitating decomposition and volatilization in Step C, the cationic surfactant B is preferably a quaternary ammonium salt, more preferably lauryltrimethylammonium chloride (dodecyltrimethylammonium chloride), stearyltrimethylammonium chloride, and behenyltrimethylammonium chloride, and still more preferably lauryltrimethylammonium chloride.

The cationic surfactant B used in the present step may be the same as or different from the cationic surfactant A used in Step A. Moreover, the cationic surfactant B can be used alone or in combination of two or more types thereof.

The mass ratio of the silanol precursor to the cationic surfactant B [silanol precursor/cationic surfactant B] is, from the viewpoint of dispersibility of the hollow silica particle precursor, preferably 3 or more, more preferably 5 or more, and even more preferably 6 or more, and is preferably 25 or less, more preferably 20 or less, and even more preferably 18 or less.

### (Alkaline Substance)

The silanol precursor is hydrolyzed to silanol by an alkaline substance, and further dehydrated and condensed to become silica.

Specific examples of the alkaline substance include those described in paragraph [0014] of JP 2016-121060 A. Among these, a quaternary ammonium hydroxide salt is preferred. Specific examples of the quaternary ammonium hydroxide salt include tetramethylammonium hydroxide, tetraethylammonium hydroxide, tetrapropylammonium hydroxide, tetrabutylammonium hydroxide, tributylmethylammonium hydroxide, trimethylhydroxyethylammonium hydroxide (choline), tetraethanolammonium hydroxide, methyltriethanolammonium hydroxide, and dimethylbis (2-hydroxyethyl) ammonium hydroxide. From the viewpoint of making the outer shell of the hollow silica particle precursor dense, tetramethylammonium hydroxide, tetraethylammonium hydroxide, trimethylhydroxyethylammonium hydroxide, and methyltriethanolammonium hydroxide, dimethylbis (2-hydroxyethyl) ammonium hydroxide are preferred, and tetramethylammonium hydroxide and dimethylbis (2-hydroxyethyl) ammonium hydroxide are more preferred.

The mass ratio of the silanol precursor to the alkaline substance [silanol precursor/alkaline substance] is, from the viewpoint of making the outer shell of the hollow silica particle precursor dense, preferably 5 or more, more preferably 10 or more, and still more preferably 20 or more, and is, from the viewpoint of efficiently performing the condensation reaction of the silanol precursor, preferably 100 or less, more preferably 80 or less, and still more preferably 70 or less.

In addition to the above quaternary ammonium hydroxide salt, the alkaline substance may contain, for example, an alkali metal salt, an alkaline earth metal salt, etc. However, in order to reduce the content of alkali metals and alkaline earth metals in the resulting hollow silica particles, the total content of alkali metals and alkaline earth metals with respect to the silanol precursor is 50 mass ppm or less in terms of silica (SiO₂). Furthermore, the content thereof is preferably 30 mass ppm or less, and more preferably 10 mass ppm or less.

By mixing the alkaline substance with the cationic surfactant B and bringing the mixture into contact with the silanol precursor, hollow silica particles having a small maximum particle diameter and an appropriate coefficient of variation can be obtained. The mixture of the alkaline substance and the cationic surfactant B may be brought into contact with the silanol precursor by adding the mixture of the alkaline substance and the cationic surfactant B to a reaction system containing the silanol precursor, or by adding the silanol precursor to a reaction system containing the mixture of the alkaline substance and the cationic surfactant B. However, from the viewpoint of increasing the porosity and productivity by increasing the synthesis concentration, it is preferable to add the mixture of the alkaline substance and the cationic surfactant B to the reaction system containing the silanol precursor.

The temperature at which Step B is performed can be adjusted as appropriate depending on the type and amount of the silanol precursor and the alkaline substance used, and is preferably 0° C. or higher and 100° C. or lower from the viewpoint of making the outer shell of the hollow silica particle precursor dense. For example, when ethyl orthosilicate or ethyl pyrosilicate is used as the silanol precursor, the temperature is preferably 20° C. or higher and 45° C. or lower, and when methyl orthosilicate or methyl pyrosilicate is used, the temperature is preferably 0° C. or higher and 20° C. or lower. Of these, it is preferable to use ethyl orthosilicate or ethyl pyrosilicate from the viewpoint of reaction control.

The time for performing Step B is, from the viewpoint of making the outer shell of the hollow silica particle precursor dense, preferably 30 minutes or more, more preferably 1 hour or more, and still more preferably 2 hours or more, and is, from the viewpoint of production efficiency, preferably 24 hours or less, more preferably 20 hours or less, and still more preferably 16 hours or less.

### (Hollow Silica Particle Precursor)

The hollow silica particle precursor is a composite silica particle having an outer shell containing silica and containing a hydrophobic liquid inside the outer shell. In the outer shell, pores using a cationic surfactant as a template are formed in a radial direction toward the center of the particle.

### [Step C]

In Step C, the hollow silica particle precursor obtained in Step B is heat-treated at a temperature higher than 1000° C. and 1200° C. or lower for 1 hour or more to decompose and volatilize the cationic surfactant present in the outer shell of the hollow silica particle precursor. After volatilizing the internal hydrophobic liquid, the pores existing in the outer shell are closed by firing to obtain hollow silica particles having a uniform outer shell.

The heat treatment temperature in Step C is, from the viewpoint of reducing the silanol groups on the surface of the hollow silica particles, preferably 1010° C. or higher, more preferably 1030° C. or higher, and still more preferably 1050° C. or higher, and is, from the viewpoint of avoiding agglomeration of the hollow silica particles, 1200° C. or lower, preferably 1190° C. or lower, more preferably 1180° C. or lower, and still more preferably 1160° C. or lower.

The heat treatment time in Step C is, from the viewpoint of reducing the silanol groups on the surface of the hollow silica particles, preferably 15 minutes or more, more preferably 30 minutes or more, and still more preferably 45 minutes or more, and is, from the viewpoint of avoiding agglomeration of the hollow silica particles, preferably 3 hours or less, more preferably 2 hours or less, and still more preferably 1.5 hours or less.

### [Resin Composition]

A resin composition can be obtained by blending the hollow silica particles of the present invention with a resin.

The resin to be blended with hollow silica is not particularly limited. However, from the viewpoint of the low dielectric property of the resin composition, it is preferable to use resins with low relative permittivity and dielectric dissipation factor, such as polyparaphenylene resins, liquid crystal polymer resins, epoxy resins using a curing agent selected from ester- and ether-based curing agents, acid anhydride-based curing agents, and imidazole-based curing agents, bismaleimide resins, cycloolefin resins, and fluorine-based resins, and derivatives of these resins.

The blending amount of the hollow silica particles in the resin composition is, from the viewpoint of lowering the relative permittivity and dielectric dissipation factor of the resin composition, preferably 10% by mass or more, more preferably 20% by mass or more, and even more preferably 30% by mass or more, and is, from the viewpoint of the viscosity and processability of the resin composition, preferably 70% by mass or less, more preferably 60% by mass or less, and even more preferably 50% by mass or less.

From the viewpoint that the resin composition of the present invention can be suitably used as an insulating material for high frequency circuit boards, the relative permittivity at a measurement frequency of 5.8 GHz is preferably 1.1 or more, more preferably 1.2 or more, and even more preferably 1.3 or more, and is preferably 2.8 or less, and more preferably 2.5 or less.

The relative permittivity of the resin composition can be determined by a method described in Examples.

From the viewpoint that the resin composition of the present invention can be suitably used as an insulating material for high frequency circuit boards, the dielectric dissipation factor at a measurement frequency of 5.8 GHz is preferably 0.0001 or more, more preferably 0.0005 or more, and even more preferably 0.001 or more, and is preferably 0.0090 or less, more preferably 0.0089 or less, and even more preferably 0.0088 or less.

The dielectric dissipation factor of the resin composition can be determined by a method described in Examples.

From the viewpoint of thermal stability of the resin composition, the linear thermal expansion coefficient of the resin composition of the present invention is preferably 70 ppm/° C. or less, more preferably 65 ppm/° C. or less, and even more preferably 60 ppm/° C. or less.

The linear thermal expansion coefficient of the resin composition can be determined by a method described in Examples.

### [Insulating Material]

When the insulating material contains the resin composition of the present invention, the insulating material can reduce transmission loss and transmission delay. The insulating material can be used for, for example, a build-up insulating film, an insulating layer of a copper-clad laminate, a prepreg, a sealing material, an insulating member of a connector, a covering material of an electric wire, etc.

### EXAMPLES

In the Examples and Comparative Examples described below, various measurements of hollow silica particles and resin compositions were performed by the following methods.

### [Measurement Method]

### (Measurement of Average Particle Diameter of Hollow Silica Particles)

The average particle diameter of the hollow silica particles was measured by a Coulter counter method using Multisizer 3 (manufactured by Beckman Coulter, Inc., using a 20 μm aperture tube).

The average particle diameter and the standard deviation of the particle diameter were determined on a volume basis, and the coefficient of variation was calculated using the following formula.

(Coefficient of variation)(%)=(Standard deviation of particle diameter)/(Average particle diameter)×100

In addition, the maximum particle diameter was set to the particle diameter at which the cumulative frequency distribution was 99%.

### (Measurement of Content of Alkali Metals and Alkaline Earth Metals in Hollow Silica Particles)

In a platinum crucible, 100 mg of hollow silica particles were charged, and 3 mL of a concentrated nitric acid, 1 mL of a concentrated hydrofluoric acid, and 1 mL of a concentrated hydrochloric acid were added thereto. After heating and evaporating to dryness, the residue in the crucible was diluted with hydrochloric acid and measured using an inductively coupled plasma mass spectrometer (trade name: Agilent 8900, manufactured by Agilent Technologies Japan, Ltd.).

### (Measurement of Relative Permittivity and Dielectric Dissipation Factor of Hollow Silica Particles)

The relative permittivity and dielectric dissipation factor of the hollow silica particles were measured by connecting a perturbation method cavity resonator (CP-580) manufactured by Kanto Electronics Application & Development Inc. to a network analyzer (trade name: N5221A, manufactured by Agilent Technologies Japan, Ltd.) and using a cavity resonator perturbation method (CP-MA dielectric constant measurement software, manufactured by Kanto Electronics Application & Development Inc.) at a temperature of 25° C. and a frequency of 5.8 GHz.

A Teflon tube (PTFE tube, inner diameter 1.5 mm, outer diameter 2.5 mm, manufactured by Chukoh Chemical Industries, Ltd.) was filled with hollow silica particles such that all the hollow silica particles are within a measurement range (6.75 mm to 36.35 mm from the bottom) to prepare a sample for measurement. The filling weight of the hollow silica particles was calculated by measuring the weight before and after filling the hollow silica particles, and the volume of the hollow silica particles filled in the Teflon tube was determined from the filling weight and specific weight of the hollow silica particles.

The relative permittivity and the dielectric dissipation factor were determined from a difference between a measured value of an empty Teflon tube not filled with the hollow silica particles, which is used as a blank, and a measured value of the Teflon tube filled with the hollow silica particles.

### (Measurement of BET Specific Surface Area of Hollow Silica Particles)

The BET specific surface area of the hollow silica particles was measured using a specific surface area measuring device (trade name “Flowsorb III 2305”, manufactured by Shimadzu Corporation). The sample was pretreated by heating at 200° C. for 15 minutes.

### (Measurement of Porosity of Hollow Silica Particles)

The porosity was calculated according to the following formula based on a density measured using a density measuring device (ULTRAPYCNMETER1200e, manufactured by Quantachrome) using nitrogen as a measurement gas. The true density of the silica particles was 2.2 g/cm³.

$$Porosity ( \% ) = [ 1 - ( true density of hollow silica particles / true density of silica particles ) ] \times 100$$

### (Measurement of Relative Permittivity and Dielectric Dissipation Factor of Resin Composition)

The dielectric constant and dielectric dissipation factor of the resin composition were determined by molding the resin composition into a diameter of 2.5 mm and a length of 4 mm, and using the cavity resonator perturbation method in the same manner as in “Measurement of Relative Permittivity and Dielectric Dissipation Factor of Hollow Silica Particles” at a frequency of 5.8 GHz.

### (Measurement of Linear Thermal Expansion Coefficient of Resin Composition)

Using a thermal stress strain measuring device (trade name “TMA7100”, manufactured by Hitachi High-Tech Science Corporation), the linear thermal expansion coefficient was measured by increasing the temperature of a cylindrical sample with a diameter of 4 mm and a length of 12 mm at a rate of 5° C. per minute in a nitrogen atmosphere at a load of 9.8 g in an expansion compression mode.

The linear thermal expansion coefficient was obtained by calculating an average linear thermal expansion coefficient in the temperature range of 50° C. to 100° C.

### (Evaluation of Appearance of Resin Composition)

The presence or absence of granular shapes on the surface of the resin composition was visually observed. In Table 2, “A” indicates that no granular shape was observed on the surface of the resin composition, “B” indicates that granular shape was slightly observed, and “C” indicates that granular shape was observed.

### (Measurement of Average Particle Diameter of Droplets Containing Hydrophobic Liquid in Emulsion)

The volume average particle diameter was determined by putting about 1 mL of an emulsion A into a rectangular cell with an optical path length of 10 mm, and measuring the particle diameter of the droplets containing the hydrophobic liquid using a light scattering device “Zetasizer Nano ZS” (manufactured by Malvern Panalytical).

### [Production of Hollow Silica Particles]

### Example 1

342.2 g of ion-exchanged water, 150 g of dodecane (primary n-dodecane, manufactured by Kishida Chemical Co., Ltd.), and 7.8 g of Quartamin 2285E (containing 58% by mass of behenyltrimethylammonium chloride, manufactured by Kao Corporation) were mixed and stirred to obtain an emulsion A. The volume average particle diameter of the particles in the obtained emulsion A was 0.5 μm.

In a reaction tank, 13146.5 g of ion-exchanged water, 184.1 g of the emulsion A, 125.6 g of Quartamin 24P (containing 27.5% by mass of lauryltrimethylammonium chloride, manufactured by Kao Corporation), and 3120.8 g of ethyl orthosilicate (TEOS999, manufactured by Wacker Asahikasei Silicone Co., Ltd.) were added and heated to 40° C. with stirring, and then the mixture was stirred for 10 minutes to obtain a preparation liquid B. Then, 221.5 g of AH212-CS (containing 50% by mass of dimethylbis (2-hydroxyethyl) ammonium hydroxide, manufactured by Yokkaichi Chemical Co., Ltd.) and 711.6 g of Quartamin 24P were uniformly mixed to obtain a preparation liquid C. The preparation liquid C was added to the preparation liquid B at a constant rate, and then the mixture was stirred at 40° C. for 3 hours to obtain a cloudy white liquid D. Thereafter, the obtained cloudy white liquid D was filtered using 5C filter paper (manufactured by Advantech Toyo Kaisha, Ltd.), washed with water, and then dried at 110° C. to obtain a white hollow silica particle precursor.

The obtained hollow silica particle precursor was fired at 1100° C. for 1 hour to obtain hollow silica particles. The properties of the obtained hollow silica particles are shown in Table 1.

### Example 2

388.6 g of ion-exchanged water, 200 g of dodecane (primary n-dodecane, manufactured by Kishida Chemical Co., Ltd.), and 11.4 g of Quartamin 86W (containing 28% by mass of stearyltrimethylammonium chloride, manufactured by Kao Corporation) were mixed and stirred to obtain an emulsion A. The volume average particle diameter of the particles in the obtained emulsion A was 0.9 μm.

Hollow silica particles were obtained in the same manner as in Example 1, except that the amount of the ion-exchanged water was 13192.5 g and the amount of the emulsion A was 138.1 g. The properties of the obtained hollow silica particles are shown in Table 1.

### Example 3

298.4 g of ion-exchanged water, 200 g of dodecane (primary n-dodecane, manufactured by Kishida Chemical Co., Ltd.), and 1.6 g of Quartamin 86W (containing 28% by mass of stearyltrimethylammonium chloride, manufactured by Kao Corporation) were mixed and stirred to obtain an emulsion A. The volume average particle diameter of the particles in the obtained emulsion A was 0.9 μm.

In a reaction tank, 1214.4 g of ion-exchanged water, 25.6 g of the emulsion A, 8.9 g of Quartamin 86W, and 146 g of ethyl orthosilicate (TEOS999, manufactured by Wacker Asahikasei Silicone Co., Ltd.) were added and stirred at 20° C. for 10 minutes to obtain a cloudy white liquid B. Thereafter, 17.5 g of tetramethylammonium hydroxide (industrial TMAH, content 25% by mass, manufactured by Showa Denko K.K.) and 60.9 g of Quartamin 86W were uniformly mixed to obtain a preparation liquid C. The preparation liquid C was added to the preparation liquid B at a constant rate, and then the mixture was stirred at 20° C. for 15 hours to obtain a cloudy white liquid D. Thereafter, the obtained cloudy white liquid B was filtered using 5C filter paper (manufactured by Advantech Toyo Kaisha, Ltd.), washed with water, and then dried at 110° C. to obtain a white hollow silica particle precursor.

The obtained hollow silica particle precursor was fired at 1100° C. for 1 hour to obtain hollow silica particles. The properties of the obtained hollow silica particles are shown in Table 1.

### Comparative Example 1

In a reaction tank equipped with a stirrer (TEM-D1500M, manufactured by Taiatsu Glass Industry Co., Ltd.), 200 g of silica (ADMAFINE SO-C2, manufactured by Admatechs Company Limited), 640 g of a 25% aqueous solution of tetramethylammonium hydroxide (pH 14, manufactured by Sachem Asia Co., Ltd.), and 160 g of ion-exchanged water were added, and while stirring, the temperature was raised to 180° C. over 1 hour and 30 minutes. Thereafter, the mixture was stirred at 180° C. for 1 hour to obtain a silica solution (silica concentration: 20% by mass, silica/organic alkali (mole ratio)=1.9).

Thereafter, 1000 g of the prepared silica solution and 1000 g of ion-exchanged water were mixed until homogeneous to obtain a diluted silica solution. The obtained diluted silica solution was spray-dried (spray drying conditions: hot air inlet temperature: 130° C., nozzle flow rate: 100 L/min, spray liquid amount: 25 mL/min) using a spray dryer (Micro Mist Spray Dryer, manufactured by GF Corporation) to obtain a dry powder. Thereafter, the dry powder obtained by spray drying was fired at 1100° C. for 1 hour to obtain hollow silica particles. The properties of the obtained hollow silica particles are shown in Table 1.

### Comparative Example 2

To 2000 g of methanol (special grade, manufactured by FUJIFILM Wako Pure Chemical Corporation), 91 g of Catiogen TML (containing 30% by mass of dodecyltrimethylammonium chloride, manufactured by DKS Co., Ltd.), 17 g of 25% aqueous solution of tetramethylammonium hydroxide (pH 14, manufactured by Sachem Asia Co., Ltd.), and 20 g of hexane (special grade, manufactured by FUJIFILM Wako Pure Chemical Corporation) were added and stirred to prepare a solution phase containing a hydrophobic organic substance and a hydrophilic organic solvent. Ion-exchanged water was simultaneously flowed out and mixed at a ratio of 1 part by volume to 1 part by volume of the solution phase to obtain an emulsified liquid. To the obtained emulsified liquid, 1500 g of ion-exchanged water was added. To the emulsified liquid after added with ion-exchanged water, 18 g of methyl orthosilicate (tetramethoxysilane) (manufactured by Tama Chemicals Co., Ltd.) was added and the mixture was stirred at 25° C. for 10 minutes to obtain a cloudy white solution. The obtained cloudy white solution was filtered using 5C filter paper (manufactured by Advantech Toyo Kaisha, Ltd.) and dried at 100° C. to obtain composite silica particles. The obtained composite silica particles were fired at 1000° C. for 38 hours to obtain hollow silica particles. The properties of the obtained hollow silica particles are shown in Table 1.

### Comparative Example 3

Hollow silica particles were obtained in the same manner as in Example 1 except that the firing temperature was 1000° C. The properties of the obtained hollow silica particles are shown in Table 1.

### Comparative Example 4

Hollow silica particles were obtained in the same manner as in Example 2 except that, instead of 221.5 g of AH212-CS (containing 50% by mass of dimethylbis (2-hydroxyethyl) ammonium hydroxide, manufactured by Yokkaichi Chemical Co., Ltd.) in Example 2, 221.5 g of 11.9 mass % aqueous solution of sodium hydroxide (manufactured by FUJIFILM Wako Pure Chemical Corporation) was used. The properties of the obtained hollow silica particles are shown in Table 1.

### Comparative Example 5

298.4 g of ion-exchanged water, 200 g of dodecane (primary n-dodecane, manufactured by Kishida Chemical Co., Ltd.), and 1.6 g of Quartamin 86W (containing 28% by mass of stearyltrimethylammonium chloride, manufactured by Kao Corporation) were mixed and stirred to obtain an emulsion A. The volume average particle diameter of the particles in the obtained emulsion A was 1.2 μm.

In a reaction tank, 1138.7 g of ion-exchanged water, 102.3 g of the emulsion A, 69.8 g of Quartamin 24P (containing 27.5% by mass of lauryltrimethylammonium chloride, manufactured by Kao Corporation), and 18.8 g of tetramethylammonium hydroxide (industrial TMAH, content 25% by mass, manufactured by Showa Denko K.K.) were added and the mixture was stirred at 15° C. for 10 minutes.

Subsequently, 260.1 g of ethyl orthosilicate (TEOS999, manufactured by Wacker Asahikasei Silicone Co., Ltd.) was added and the mixture was stirred at 25° C. for 15 hours to obtain a cloudy white liquid B. Thereafter, the obtained cloudy white liquid B was filtered using 5C filter paper (manufactured by Advantech Toyo Kaisha, Ltd.), washed with water, and then dried at 110° C. to obtain a white hollow silica particle precursor.

The obtained hollow silica particle precursor was fired at 1100° C. for 1 hour to obtain hollow silica particles. The properties of the obtained hollow silica particles are shown in Table 1.

TABLE 1

| | Average | Maximum | Coefficient | |
|---|---|---|---|---|
| | particle | particle | of | Metal |
| | diameter | diameter | variation | content |
| | (μm) | (μm) | (%) | (ppm) *1 |
| Example 1 | 1.0 | 2.3 | 34 | 10 |
| Example 2 | 1.8 | 2.9 | 27 | 10 |
| Example 3 | 1.9 | 3.1 | 35 | 10 |
| Comparative | 3.1 | 6.9 | 46 | 10 |
| Example 1 | | | | |
| Comparative | 1.2 | 1.8 | 17 | 10 |
| Example 2 | | | | |
| Comparative | 1.8 | 3.5 | 35 | 10 |
| Example 3 | | | | |
| Comparative | 1.3 | 2.5 | 30 | 820 |
| Example 4 | | | | |
| Comparative | 2.3 | 9.1 | 98 | 10 |
| Example 5 | | | | |

| | | Specific | Relative | Dielectric |
|---|---|---|---|---|
| | Porosity | surface area | permittivity | dissipation |
| | (%) | (m²/g) *2 | *3 | factor *4 |
| Example 1 | 71 | 16.7 | 1.6 | 0.0043 |
| Example 2 | 70 | 9.8 | 1.6 | 0.0035 |
| Example 3 | 73 | 11.1 | 1.6 | 0.0041 |
| Comparative | 32 | 6.0 | 2.2 | 0.0105 |
| Example 1 | | | | |
| Comparative | 40 | 8.0 | 2.1 | 0.0060 |
| Example 2 | | | | |
| Comparative | 73 | 25.8 | 1.5 | 0.0180 |
| Example 3 | | | | |
| Comparative | 39 | 11.0 | 2.0 | 0.0032 |
| Example 4 | | | | |
| Comparative | 58 | 22.1 | 1.8 | 0.0091 |
| Example 5 | | | | |

*1 a total amount of alkali metals and alkaline earth metals (mass ppm) with respect to silica content.
*2 BET specific surface area.
*3 relative permittivity at a measurement frequency of 5.8 GHz.
*4 dielectric dissipation factor at a measurement frequency of 5.8 GHz.

As shown in the results in Table 1, in the hollow silica particles produced by the production method of the present invention, it was possible to reduce the average particle diameter, and to lower the relative permittivity and dielectric dissipation factor at a measurement frequency of 5.8 GHz even when the total content of alkali metals and alkaline earth metals was reduced relative to the silica content in the hollow silica particles.

On the other hand, in the hollow silica particles of Comparative Example 1 produced by spray drying, the average particle diameter could not be reduced, and the dielectric dissipation factor became high. Furthermore, in Comparative Examples 2 and 3, the firing temperature was low, and thus the hollow silica particles of Comparative Examples 2 and 3 had high dielectric dissipation factors. In Comparative Example 2, it is thought that since tetramethoxysilane as a silanol precursor was hydrolyzed and condensed at 25° C., a dense outer shell was not formed, which results in a low porosity. In Comparative Example 4, since sodium hydroxide was used as a catalyst, the total content of alkali metals and alkaline earth metals in the hollow silica particles was high. As a result, the heat resistance decreased, and the relative permittivity increased as the porosity decreased. In Comparative Example 5, after the cationic surfactant B and the alkaline substance being added to the aqueous emulsion obtained in Step A, the silanol precursor was finally added thereto and the silanol precursor was hydrolyzed, so that the dielectric dissipation factor increased as the specific surface area increased.

### [Production of Resin Composition]

### Example 4

Using a kneader (Planetary Vacuum Mixer, manufactured by Thinky Corporation), 23.7 g of an epoxy resin (jER (trademark) 828, manufactured by Mitsubishi Chemical Corporation), 28.8 g of an acid anhydride curing agent (YH-306, manufactured by Mitsubishi Chemical Corporation), and 0.3 g of an imidazole curing agent (EMI24, manufactured by Mitsubishi Chemical Corporation) were kneaded at 1400 rpm for 1 minute under atmospheric pressure and at 2000 rpm for 5 minutes under reduced pressure of 0.3 kPa to obtain an epoxy resin kneading liquid.

In a kneader (Planetary Vacuum Mixer, manufactured by Thinky Corporation), 2 g of the obtained epoxy resin kneading liquid and 1.2 g of the hollow silica particles obtained in Example 1 were kneaded at 1400 rpm for 1 minute under atmospheric pressure and at 2000 rpm for 5 minutes under reduced pressure of 0.3 kPa to obtain an epoxy resin hollow silica particle kneading liquid.

The obtained epoxy resin hollow silica particle kneading liquid was subjected to curing treatment at 160° C. for 6 hours to obtain a resin composition. The properties of the obtained resin composition are shown in Table 2.

### Example 5

A resin composition was obtained in the same manner as in Example 4, except that the hollow silica particles obtained in Example 2 were used instead of the hollow silica particles obtained in Example 1. The properties of the obtained resin composition are shown in Table 2.

### Example 6

A resin composition was obtained in the same manner as in Example 4, except that the hollow silica particles obtained in Example 3 were used instead of the hollow silica particles obtained in Example 1. The properties of the obtained resin composition are shown in Table 2.

### Comparative Example 6

A resin composition was obtained in the same manner as in Example 4, except that 2.7 g of the hollow silica particles obtained in Comparative Example 1 were used instead of 1.2 g of the hollow silica particles obtained in Example 1.

### Comparative Example 7

A resin composition was obtained in the same manner as in Example 4, except that 4 g of solid silica particles (ADMAFINE SO-C2, manufactured by Admatechs Company Limited) were used instead of 1.2 g of the hollow silica particles obtained in Example 1.

### Comparative Example 8

A resin composition was obtained in the same manner as in Example 4, except that the hollow silica particles were not kneaded.

### Comparative Example 9

A resin composition was obtained in the same manner as in Example 4, except that 2.4 g of the hollow silica particles obtained in Comparative Example 4 were used instead of 1.2 g of the hollow silica particles obtained in Example 1. The properties of the obtained resin composition are shown in Table 2.

### Comparative Example 10

A resin composition was obtained in the same manner as in Example 4, except that 1.7 g of the hollow silica particles obtained in Comparative Example 5 were used instead of 1.2 g of the hollow silica particles obtained in Example 1. The properties of the obtained resin composition are shown in Table 2.

In Examples 4 to 6 and Comparative Examples 6 to 7, and 9 to 10, the volume ratios of the resin and the hollow silica particles or the solid silica particles are all the same.

TABLE 2

| | | | After storage under high | |
|---|---|---|---|---|
| | Immediately after preparation | | temperature and high humidity *5 | |
| | Relative | Dielectric | Relative | Dielectric |
| | permittivity | dissipation factor | permittivity | dissipation factor |
| | *3 | *4 | *3 | *4 |
| Example 4 | 2.4 | 0.0087 | 2.4 | 0.0087 |
| Example 5 | 2.4 | 0.0085 | 2.4 | 0.0085 |
| Example 6 | 2.4 | 0.0085 | 2.4 | 0.0086 |
| Comparative | 2.7 | 0.0100 | 2.7 | 0.0100 |
| Example 6 | | | | |
| Comparative | 2.9 | 0.0084 | 2.9 | 0.0084 |
| Example 7 | | | | |
| Comparative | 2.8 | 0.0120 | 2.8 | 0.0120 |
| Example 8 | | | | |
| Comparative | 2.7 | 0.0103 | 2.6 | 0.0110 |
| Example 9 | | | | |
| Comparative | 2.8 | 0.0101 | 2.8 | 0.0101 |
| Example 10 | | | | |

| | Increased amount | | Linear expansion | |
|---|---|---|---|---|
| | Relative | Dielectric | coefficient | |
| | permittivity | dissipation factor | (ppm/° C.) | Appearance |
| Example 4 | 0.0 | 0.0000 | 54 | A |
| Example 5 | 0.0 | 0.0000 | 55 | A |
| Example 6 | 0.0 | 0.0001 | 55 | A |
| Comparative | 0.0 | 0.0000 | 58 | C |
| Example 6 | | | | |
| Comparative | 0.0 | 0.0000 | 53 | A |
| Example 7 | | | | |
| Comparative | 0.0 | 0.0000 | 79 | A |
| Example 8 | | | | |
| Comparative | 0.0 | 0.0033 | 56 | A |
| Example 9 | | | | |
| Comparative | 0.0 | 0.0001 | 57 | C |
| Example 10 | | | | |

*3 relative permittivity at a measurement frequency of 5.8 GHz.
*4 dielectric dissipation factor at a measurement frequency of 5.8 GHz.
*5 stored at 60° C. and 90% RH for 5 days.

As shown in the results in Table 2, in the resin composition containing the hollow silica particles of the present invention, it was possible to lower the relative permittivity and dielectric dissipation factor at a measurement frequency of 5.8 GHz.

On the other hand, the resin compositions of Comparative Examples 6 to 8 containing the hollow silica particles of Comparative Examples 1 to 3 had high relative permittivities, and the resin compositions of Comparative Examples 6 and 8 also had high dielectric dissipation factors. The resin composition of Comparative Example 9 containing the hollow silica particles of Comparative Example 4 had a high dielectric dissipation factor. The resin composition of Comparative Example 10 containing the hollow silica particles of Comparative Example 5 had a high dielectric dissipation factor and poor appearance.

From the above, an insulating material containing the resin composition of the present invention can be used as an insulating material in a high frequency circuit that supports high frequency radio waves.

1. A method for producing hollow silica particles having an average particle diameter of 0.5 μm or more and 3.0 μm or less and a total content of alkali metals and alkaline earth metals of 50 mass ppm or less with respect to a content of the silica in the particles, wherein
the hollow silica particles have a relative permittivity of 2.5 or less and a dielectric dissipation factor of 0.0050 or less at a measurement frequency of 5.8 GHz, and
the method comprises the following steps:
Step A: a step of making an aqueous emulsion of a hydrophobic liquid using a cationic surfactant A;
Step B: a step of adding, to the aqueous emulsion obtained in Step A, a silanol precursor, an alkaline substance, and a cationic surfactant B, and generating a hollow silica particle precursor; and
Step C: a step of heat-treating the hollow silica particle precursor obtained in Step B at a temperature higher than 1000° C. and 1200° C. or lower for one hour or more.

2. The method for producing hollow silica particles according to claim 1, wherein Step B is a step of adding the alkaline substance and the cationic surfactant B in the presence of the aqueous emulsion obtained in Step A and the silanol precursor, and generating the hollow silica particle precursor.

3. The method for producing hollow silica particles according to claim 1, wherein the adding step in Step B is carried out by adding a mixture of the alkaline substance and the cationic surfactant B to the aqueous emulsion containing the silanol precursor.

4. The method for producing hollow silica particles according to claim 1, wherein the adding step in Step B is carried out by bringing the aqueous emulsion containing the silanol precursor into contact with the alkaline substance mixed with the cationic surfactant B.

5. The method for producing hollow silica particles according to claim 1, wherein the alkaline substance is a quaternary ammonium hydroxide salt.

6. The method for producing hollow silica particles according to claim 1, wherein both the cationic surfactant A and the cationic surfactant B are quaternary ammonium salts.

7. The method for producing hollow silica particles according to claim 1, wherein the silanol precursor is selected from an orthosilicate alkyl ester and a pyrosilicate alkyl ester.

8. Hollow silica particles having an average particle diameter of 0.5 μm or more and 3.0 μm or less and a total content of alkali metals and alkaline earth metals of 50 mass ppm or less with respect to a content of the silica in the particles, wherein
the hollow silica particles have a relative permittivity of 2.5 or less and a dielectric dissipation factor of 0.0050 or less at a measurement frequency of 5.8 GHz.

9. The hollow silica particles according to claim 8, having a porosity of 50% by volume or more and 80% by volume or less.

10. The hollow silica particles according to claim 8, having a BET specific surface area of 30 m²/g or less.

11. The hollow silica particles according to claim 8, having a coefficient of variation of average particle diameter of 15% or more and 300% or less.

12. The hollow silica particles according to claim 8, having a maximum particle diameter of 5.0 μm or less.

13. A resin composition blended with the hollow silica particles according to claim 8.

14. The resin composition according to claim 13, having a relative permittivity of 2.8 or less and a dielectric dissipation factor of 0.0090 or less at a measurement frequency of 5.8 GHz.

15. The resin composition according to claim 13, having a linear thermal expansion coefficient of 70 ppm/° C. or less.

16. An insulating material comprising the resin composition according to claim 13.

17. The method for producing hollow silica particles according to claim 1, wherein in Step A, the mass ratio of the cationic surfactant A to the hydrophobic liquid [cationic surfactant A/hydrophobic liquid] is 0.0005 or more and 0.05 or less.

18. The method for producing hollow silica particles according to claim 1, wherein the mass ratio of the silanol precursor to the hydrophobic liquid [silanol precursor/hydrophobic liquid] is 10 or more and 90 or less.

19. The method for producing hollow silica particles according to claim 1, wherein the mass ratio of the silanol precursor to the cationic surfactant B [silanol precursor/cationic surfactant B] is 3 or more and 25 or less.

20. The method for producing hollow silica particles according to claim 1, wherein the mass ratio of the silanol precursor to the alkaline substance [silanol precursor/alkaline substance] is 5 or more and 100 or less.

21. The method for producing hollow silica particles according to claim 1, wherein the relative permittivity of the hollow silica particles is measured by a cavity resonator perturbation method at a measurement frequency of 5.8 GHz.
